(19) United States
(12) Patent Application Publication
(10) Pub. No.: US 2008/0297371 A1
(43) Pub. Date: Dec. 4, 2008

(54) ELECTRONIC APPARATUS AND CONNECTED APPARATUS SEARCHING METHOD

(75) Inventor: Tomotaka IDA, Saitama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/939,603

(22) Filed: Nov. 14, 2007

(30) Foreign Application Priority Data
May 28, 2007 (JP) 2007-140431

(51) Int. Cl. H02J 13/00

(52) U.S. Cl. 340/825.52

(57) ABSTRACT

An address number of “1” in a logic address is firstly set, and polling is performed. When there is a response to the polling, a physical address and a device name as response contents are written to and registered in an address list so as to correspond to the address number of “1” in the logic address. When some address numbers in the logic address for each of which no connection confirmation is performed exist in a next device type, the smallest address number in the logic address is selected, and an operation returns back to Step S11. Next, when the connection confirmation for each of all the device types is completed, the polling is performed for each of the remaining address numbers in the logic address. When there are responses to the polling, the physical addresses and the device names about the connections each making the response to the polling are written to and registered in the address list.

The present application is based on Japanese patent application No. 2007-140431 on May 28, 2007, the entire contents of which are incorporated herein by reference.

### BACKGROUND

1. Field

One embodiment of the invention relates to an electronic apparatus and a method of searching for external apparatuses connected to the same.

2. Description of the Related Art

An electronic apparatus which automatically making correspondence between physical addresses and logic addresses of external apparatuses connected to the electronic apparatus is known as the related art. This electronic apparatus, for example, is described in Japanese Patent No. 3567438.

This electronic apparatus includes a signal line through which a plurality of external apparatuses are connected in parallel with the electronic apparatus, and a control line through which the plurality of apparatuses are connected in series with the electronic apparatus.

This electronic apparatus sets apparatus addresses in a range previously determined every type in the order of supply of an electric power, instructs external apparatuses to transmit thereto signals in the order of increasing the apparatus address, receives the signals which the external apparatuses transmit thereto, respectively, in accordance with the instruction at its terminal, and makes correspondence between logic addresses with which the terminal receiving thereat the signals is associated, and the apparatus addresses of the external apparatuses transmitting thereto the signals, respectively. For this reason, the electronic apparatus can automatically make the correspondence between the apparatus addresses and the logic addresses of a plurality of external apparatuses.

However, according to the conventional electronic apparatus, although the correspondence between the apparatus addresses and the logic addresses of the external apparatuses connected thereto can be automatically made, the correspondence is made through a step of setting the apparatus addresses in the order of supply of the electric power (that is, in the order of increasing the apparatus address), and instructs the external apparatuses to show the respective apparatus addresses different from the original ones. Here, the step is not included in the essential method of searching for the external apparatuses connected to the electronic apparatus. Therefore, the method of searching for the external apparatuses connected to the electronic apparatus in the related art is not necessarily said to be the effective one.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view showing an HDMI system according to a first embodiment of the invention;

FIGS. 2A and 2B are respectively an exemplary block diagram showing a configuration of the HDMI system according to the first embodiment of the invention, and an exemplary diagram showing an example of a description of physical addresses;

FIG. 3 is an exemplary block diagram showing a configuration of a television in the HDMI system according to the first embodiment of the invention;

FIGS. 4A and 4B are respectively an exemplary diagram showing a structure of a logic address assignment table in the first embodiment of the invention, and an exemplary diagram showing a structure of an address list in the first embodiment of the invention;

FIG. 5 is an exemplary flow chart showing an operation of the television according to the first embodiment of the invention;

FIG. 6 is an exemplary flow chart showing an operation of a television according to a second embodiment of the invention;

FIG. 7 is an exemplary flow chart showing an operation of a television according to a third embodiment of the invention;

FIG. 8 is an exemplary diagram showing a setting menu displayed on a display portion of a television according to a fourth embodiment of the invention;

FIG. 9 is an exemplary diagram showing a structure of a priority address list in the fourth embodiment of the invention; and

FIG. 10 is an exemplary flow chart showing an operation of the television according to the fourth embodiment of the invention.

### DETAILED DESCRIPTION OF PREFERRED EMBODIMENTS

Various embodiments according to the invention will be described hereinafter with reference to the accompanying drawings. In general, according to one embodiment of the invention, there is provided an electronic apparatus, including: a communication line through which the electronic apparatus communicates with a plurality of external apparatuses; a memory portion for storing therein an address list in which correspondence between logic addresses and physical addresses of the plurality of external apparatuses is made; and a control portion for determining a search order for the logic addresses in accordance with a predetermined rule, searching for the plurality of external apparatuses connected to the electronic apparatus through the communication line in accordance with the search order, acquiring the physical addresses from the plurality of external apparatuses, and writing the physical addresses thus acquired to the address list.

According to the one embodiment having the constitution described above of the invention, conventionally, the connection confirmation is performed in the order of increasing the address number in the logic address, whereas the connection confirmation is performed in the order of decreasing the possibility that the external apparatus is connected to the electronic apparatus. Therefore, although the processing time required for the connection confirmation remains unchanged, the electronic apparatus can confirm in an early stage the connection of the external apparatuses to the electronic apparatus. As a result, the operation of the electronic apparatus can quickly proceed to the recognition of the external apparatuses on the electronic apparatus, and the manipulation for the external apparatuses through the electronic apparatus.

According to a further embodiment of the invention, there is provided an electronic apparatus, including: a communication line through which the electronic apparatus communicates with a plurality of external apparatuses; a memory portion for storing therein an address list in which correspondence between logic addresses and physical addresses of the plurality of external apparatuses is made, and a last-time address list in which a history about the correspondence between the logic addresses and the physical addresses of the plurality of external apparatuses is stored; and a control portion for determining a search order for the logic addresses in accordance with the logic addresses of the external apparatuses described in the last-time address list preferentially and a predetermined rule, searching for the plurality of external apparatuses connected to the electronic apparatus through the communication line in accordance with the search order, acquiring the physical addresses from the plurality of external apparatuses, and writing the physical addresses thus acquired to the address list.

According to the further embodiment having the constitution described above of the invention, the connection confirmation can be performed in the order of decreasing the possibility that the external apparatus is connected to the electronic apparatus by using a history about the correspondence between the logic addresses and the physical addresses of the external apparatuses. Thus, although the processing time required for the connection confirmation remains unchanged, the electronic apparatus can confirm in an early stage the connection of the external apparatuses to the electronic apparatus. As a result, the operation of the electronic apparatus can quickly proceed to the recognition of the external apparatuses on the electronic apparatus, and the manipulation for the external apparatuses through the electronic apparatus.

In addition, according to a still further embodiment of the invention, there is provided a connected apparatus searching method, including the steps of: determining a search order for logical addresses in accordance with a predetermined rule; searching for a plurality of external apparatuses in accordance with the search order thus determined; and acquiring physical addresses from the plurality of external apparatuses thus searched for, and writing physical addresses to an address list so as to correspond to the logic addresses, respectively.

According to the still further embodiment of the method having the steps described above of the invention, it is possible to realize the connected apparatus searching method in which the same effects as those of the one embodiment of the invention are obtained.

According to the embodiments of the invention, it is possible to efficiently search the external apparatuses connected to the electronic apparatus.

Hereinafter, embodiments of the invention will be described in detail with reference to the accompanying drawings.

### First Embodiment

### (Constitution)

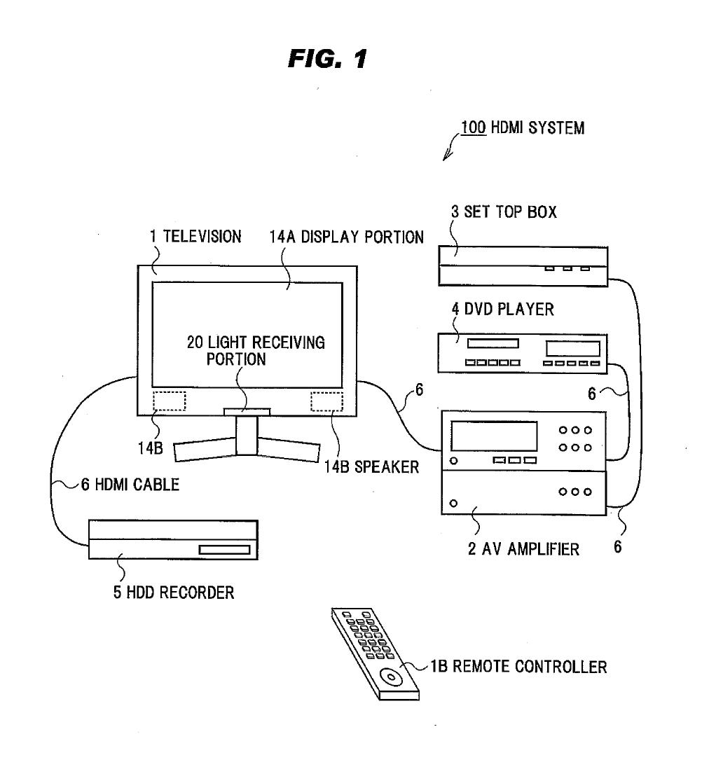

FIG. 1 is a high-definition multimedia interface (HDMI) system according to a first embodiment of the invention.

The HDMI system 100 includes a television 1 as an electronic apparatus for receiving and demodulating a terrestrial digital broadcasting wave through its antenna, and displaying a program of the terrestrial digital broadcasting on its screen, or receiving a video signal from an external input and displaying an image from the video signal on its screen, an audio and visual (AV) amplifier 2 for amplifying and reproducing an audio signal inputted thereto from corresponding one of external apparatuses, or switching a video signal and an audio signal output inputted from corresponding one of the external apparatuses, a set top box 3 as a tuner for receiving and demodulating a satellite broadcasting such as a broadcast satellite (BS) or a communication satellite (CS), a DVD player 4 for reproducing data stored in a medium such as a high-definition digital versatile disc (HD DVD) or a DVD, and a hard disc drive (HDD) recorder 5 for recording therein a video signal from a broadcasting and an external input, and outputting the contents recorded therein to the outside. In this case, the television 1, the AV amplifier 2, the set top box 3, the DVD player 4, and the HDD recorder 5 are connected to one another through HDMI cables 6, respectively, as shown in the figure. A remote controller 1B is exclusive one by using which the television 1 is manipulated. However, the remote controller 1B can also transmit an instruction signal to any other electronic apparatus through the corresponding one of the HDMI cables 6, thereby manipulating the any other electronic apparatus.

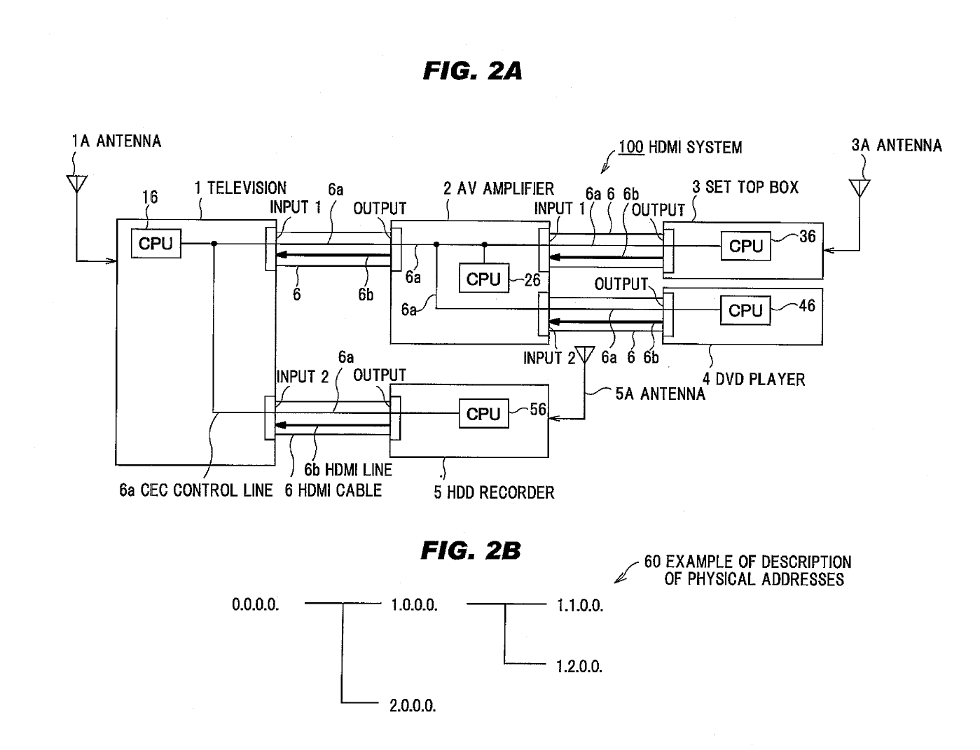

The television 1 confirms that the AV amplifier 2, the set top box 3, the DVD player 4, and the HDD recorder 5 are connected to the television 1 through the respective HDMI cables 6 when a power source of the television 1 is turned ON. In addition thereto, the television 1 periodically confirms the connection of these external apparatuses 2, 3, 4 and 5 to the television 1 during its normal operation. The transmission and reception of information on the connection confirmations are performed by using consumer electronics control (CEC) lines 6a (refer to FIG. 2A) of the HDMI cables 6.

FIGS. 2A and 2B are respectively a block diagram showing a configuration of the HDMI system according to the first embodiment of the invention, and a diagram showing an example of a description of physical addresses.

As shown in FIG. 2A, the television 1 has an input 1 and an input 2 of an HDMI terminal. An output of the AV amplifier 2 is connected to the input 1 of the television 1 through the corresponding one of the HDMI cables 6, and an output of the HDD recorder 5 is connected to the input 2 of the television 1 through the corresponding one of the HDMI cables 6. In addition, the television 1 receives the terrestrial digital broadcasting wave through an antenna 1A.

The AV amplifier 2 has an input 1 and an input 2 of an HDMI terminal. An output of the set top box 3 is connected to the input 1 of the AV amplifier 2 through the corresponding one of the HDMI cables 6, and an output of the DVD player 4 is connected to the input 2 of the AV amplifier 2 through the corresponding one of the HDMI cables 6. In addition, the set top box 3 receives the broadcasting waves of the BS and the CS through an antenna 3A.

The HDD recorder 5 receives the terrestrial digital broadcasting wave through an antenna 5A.

The HDMI cable 6 has CEC control lines 6a and HDMI lines 6b. The CEC control lines 6a are connected in series among CPUs 16, 26, 36, 46, and 56 of the television 1, the AV amplifier 2, the set top box 3, the DVD player 4, and the HDD recorder 5. The HDMI lines 6b are connected between the television 1 and the AV amplifier 2, between the AV amplifier 2 and the set top box 3, between the AV amplifier 2 and the DVD player 4, and between the television 1 and the HDD recorder 5, respectively, so as to transmit the video signal and the audio signal.

FIG. 2B shows an example of a description of physical addresses in which the physical addresses are described which are set in the television 1, the AV amplifier 2, the set top box 3, the DVD player 4, and the HDD recorder 5, respectively, when the television 1, the AV amplifier 2, the set top box 3, the DVD player 4, and the HDD recorder 5 are connected in the manner as shown in FIG. 2A. The physical addresses of “0.0.0.0”, “1.0.0.0”, “1.1.0.0”, “1.2.0.0”, and “2.0.0.0” are described for the television 1, the AV amplifier 2, the set top box 3, the DVD player 4, and the HDD recorder 5, respectively. The physical address of the television 1 is described as a numerical character of a zeroth hierarchy, and a number of the input 1 of the television 1 to which the output of the AV amplifier 2 is connected is described as a numerical character of a first hierarchy. Thus, the physical addresses are described for a second hierarchy, and a third hierarchy, and a fourth hierarchy, respectively, similarly to the zeroth and first hierarchies. As a result, it is possible to construct the HDMI system 100 having the five hierarchies from the television 1.

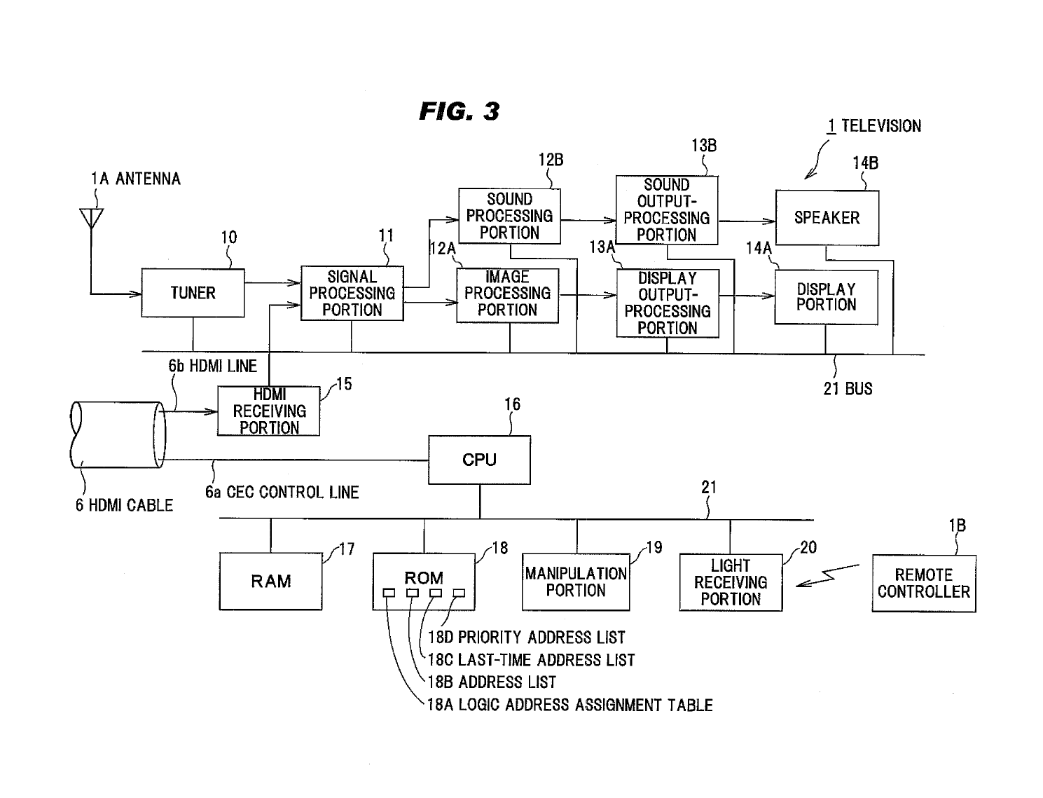

FIG. 3 is a block diagram showing a configuration of the television according to the first embodiment of the invention.

The television 1 includes a tuner 10 for receiving the terrestrial digital television broadcasting wave through the antenna 1A, and selecting a channel, a signal processing portion 11 for demultiplexing an output from the tuner 10 into video data, audio data, caption data and the like, and processing the video data, the audio data, the caption data and the like, an image processing portion 12A for decoding an output of the video data and the caption data from the signal processing portion 11, a display processing portion 13A for converting an output from the video processing portion 12A into a video signal for display, and outputting the resulting video signal for display, a display portion 14A for displaying an output from the display processing portion 13A on a liquid crystal display (LCD) panel, a sound processing portion 13B for decoding an output of audio data from the signal processing portion 11, a sound output-processing portion 13B for converting an output from the sound processing portion 12B into an audio signal, and outputting the resulting audio signal, a speaker 14B for converting an output from the sound output-processing portion 13B into a voice, an HDMI receiving portion 15 for receiving video data, audio data and caption data from the outside through the corresponding one of the HDMI lines 6b of the HDMI cables 6, a central processing unit (CPU) for transmitting/receiving CEC control data from the outside through the corresponding one of the CEC control lines 6a of the HDMI cables 6, thereby controlling the portions of the television 1, a random access memory (RAM) 17 for temporarily storing therein data processed by the CPU 16, a read only memory (ROM) 18 for storing therein a logic address assignment table 18A, an address list 18B, a last-time address list 18C, a priority address list 18D, video contents, and the like, a manipulation portion 19 including a plurality of switches, and the like for manipulating the television 1 in accordance with an input(s) inputted by manipulating corresponding one(s) of the plurality of switches, and the like, and a light receiving portion 20 for receiving an instruction transmitted thereto in the form of an infrared signal radiated from the remote controller 1B. These portions are connected to one another through a bus 21.

It is noted that the HDMI cable 6 is connected to an HDMI connector (not shown), and also is connected to each of the HDMI receiving portion 15 and the CPU 16 through an interface of the HDMI.

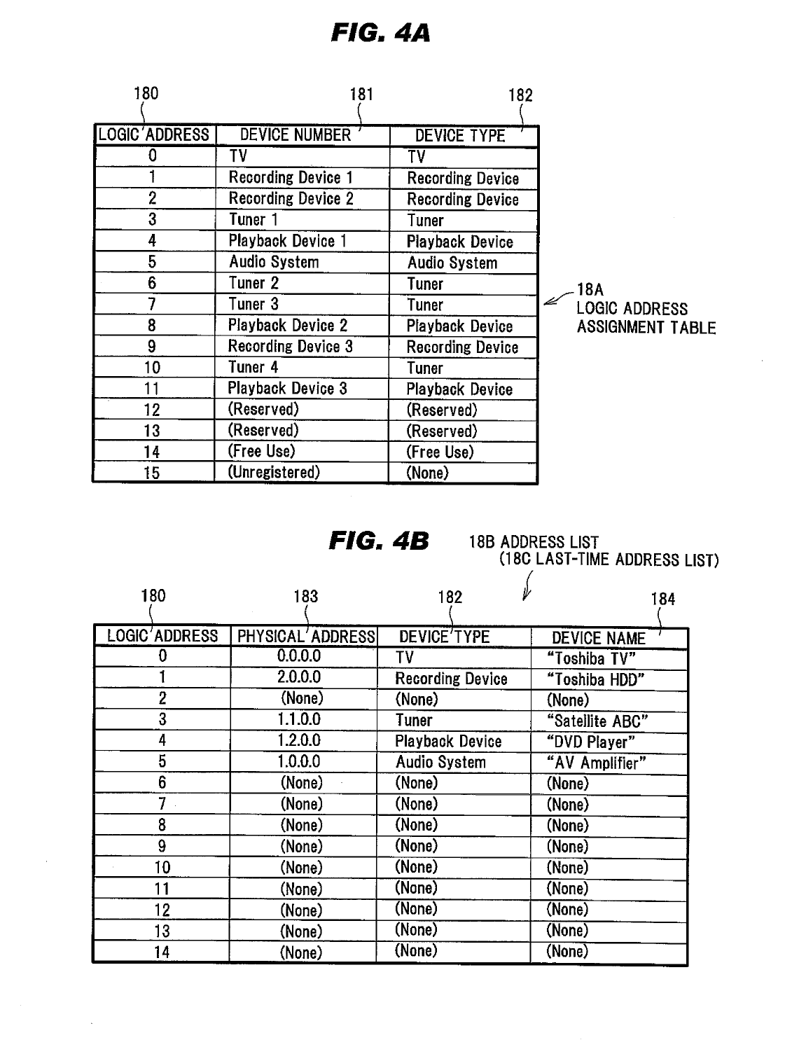

FIGS. 4A and 4B are respectively a diagram showing a structure of the logic address assignment table in the first embodiment of the invention, and a diagram showing a structure of the address list in the first embodiment of the invention.

As shown in FIG. 4A, the logic address assignment table 18A is a table in which correspondence among a logic address 180, a device number 181 and a device type 182 is made in accordance with the HDMI-CEC standard. In the logic address assignment table 18, sixteen address numbers of “0” to “15” in a logic address 180 are prepared.

The device numbers 181 and device types 182 as described in the logic address assignment table 18A are set for the address numbers of “0” to “11” in the logic address 180. However, at a time point of May 2007, none of the device number 181 and the device type 182 is set for each of the address numbers of “12” and “13” in the logic number 180. Therefore, none of these address numbers in the logic address 180 can be used.

An arbitrary device number 181 and an arbitrary device type 182 can be set for the address number of “14” in the logic address 180 because of a description of “Free Use”. For example, the address number of “14” in the logic address 180 can be used in the case where one more recording device is desired to be added in a state in which the recording devices from Recording Device 1 to Recording Device 3 are used. Although the address number of “15” in the logic address 180 cannot be used in a single apparatus itself, when carrying out an instruction, the television 1 transmits the instruction to each of all the apparatuses other than the apparatuses using other address numbers in the logic address, respectively.

As shown in FIG. 4B, when the television 1 confirms that an external apparatus is connected to the television 18B through the corresponding one of the HDMI cables 6, the address list 18B is produced by writing thereto the physical address 183 and the device name 184 of the external apparatus concerned. In this case, in the HDMI system 100 shown in FIGS. 2A and 2B, there is described the case where the television 1 confirms that the AV amplifier 2, the set top box 3, the DVD player 4, and the HDD recorder 5 are connected to the television 1.

(Operation)

Hereinafter, an operation of the television according to the first embodiment of the invention will be described in detail with reference to FIGS. 1 to 5.

Firstly, when the power source of the television 1 is turned ON by manipulating either the manipulation portion 19 or the remote controller 1B, the CPU 16 executes processing for activating the television 1. The activation processing includes operations such as an operation for initializing the portions of the television 1, and an operation for reading out the set data. The CPU 16 not only executes the activation processing, but also confirms that the external apparatuses are connected to the television 1 through the corresponding ones of the HDMI cables 6. The connection confirmation is performed in accordance with the logic address assignment table 18A. That is to say, the connection confirmation is performed by writing the physical addresses 183 and the device names 184 of the external apparatuses connected to the television 1 to the address list 18B so as to correspond to the respective address numbers in the logic address 180.

When confirming that the external apparatuses are connected to the television 1 so as to correspond to the respective address numbers in the logic address 180, the CPU 16 performs polling for each of the external apparatuses connected to the television 1 by using a command called “<Give Physical Address>” defined by the HDMI standard 1.2. The polling, for example, is repeatedly performed five times in order to improve the reliability of the connection. When the external apparatus for which the polling is performed is connected to the television 1 so as to correspond to the address number in the logic address 180, the external apparatus transmits the physical address 183 and the device name 184 as a response to the polling to the television 1. However, the address number of “0” in the logic address 180 points to the television 1 itself, and thus firstly, the television 1 itself is registered in the address number of “0” in the logic address 180.

After completing all the activation processing including the connection confirmation, the television 1 starts its normal operation. It is noted that the polling is performed five times for each of the address numbers in the logic address 180, which results in that a time period of about 2 to about 3 seconds is required for the entire connection confirmation in the phase of the activation. Hereinafter, an operation for the connection confirmation when the television 1 executes the activation processing will be described in detail.

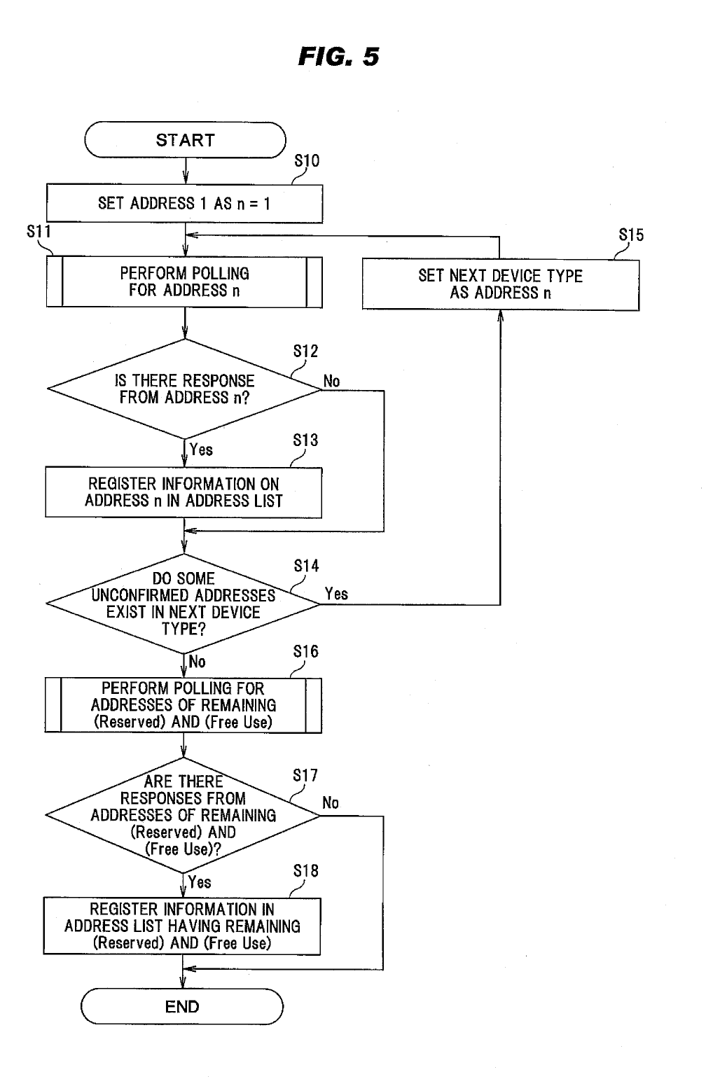

FIG. 5 is a flow chart showing the operation of the television according to the first embodiment of the invention.

Firstly, the CPU 16 sets n=1 in order to confirm the connection of the external apparatus corresponding to the address number of “1” in the logic address 180 (Step S10). Next, the CPU 16 performs the polling “<Give Physical Address>” for the address number of “1” in the logic address 180, that is, for “Recording Device 1” (Step S11). When there is a response from the external apparatus corresponding to the address number of “1” in the logic address 180 because that external apparatus is connected to the television 1 so as to correspond to the address number of “1” in the logic address 180 (Step S12: Yes), the physical address 183 and the device name 184 of the external apparatus concerned as the response contents are written to and registered in the address list 18B so as to correspond to the address number of “1” in the logic address 180 (Step S13). On the other hand, when there is no response from the external apparatus concerned (Step S12: No), none of the physical address 183 and the device name 184 of the external apparatus concerned is written to the address list 18B, and the operation of the television 1 proceeds to a next step.

Next, when some address numbers in the logic address 180 for each of which no connection confirmation is performed exist in the address numbers of “3” , “6” and “7” in the logic address 180 each corresponding to “Tuner” as the device type 182 next to “Recording Device” (Step S14: Yes), the smallest address number in the logic address 180 for which no connection confirmation is performed is selected as the address number in the logic address 180. For example, when no connection confirmation is performed for each of the address numbers of “3”, “6” and “7” in the logic address 180, the address number of “3” in the logic address 18 is selected as the address number in the logic address 180 (Step S15), and the operation of the television 1 returns back to the processing in Step S11.

Here, all the connection confirmations are not performed in the phase of the activation of the television 1. Hence, by repeatedly executing the processing from Step S11 to Step S15, the connection confirmation is performed for the address numbers in the logic address 180 in the order as will be described below: “1 (Recording Device 1)”, “3 (Tuner 1)”, “4 (Playback Device 1)”, “5 (Audio System)”, “2 (Recording Device 2)”, “6 (Tuner 2)”, “8 (Playback Device 2)”, “7 (Tuner 3)”, “9 (Recording Device 3)”, “11 (Playback Device 3)”, and “10 (Tuner 4)”. That is to say, the connection confirmation is repeatedly performed such that the connection confirmation is performed for the external apparatus belonging to first one of all the device types 182, and when the connection confirmation is performed for all the external apparatuses belonging to the first device type 182, the connection confirmation is performed for the external apparatuses belonging to second one of all the device types 182.

Next, when the connection confirmation is completed for the external apparatuses belonging to all the device types 182 (Step S14: No), the polling is performed for the external apparatuses connected to the television 1 so as to correspond to the address numbers of “12” to “15” in the logic address 180, respectively (Step S16). When there are responses, to the polling, from the external apparatuses connected to the television 1 so as to correspond to the address numbers of “12” to “15” in the logic address 180, respectively (Step S17: Yes), the physical addresses 183 and the device names 184 of the external apparatuses, connected to the television 1, each making the response to the polling are written to and registered in the address list 18B (S18). On the other hand, when there is no response, to the polling, from none of the external apparatuses connected to the television 1 so as to correspond to the address numbers of “12” to “15” in the logic address 180, respectively (Step S17: No), the connection confirmation is completed.

According to the first embodiment described above of the invention, conventionally, the connection confirmation is performed in the order of increasing the address number in the logic address 180, whereas the connection confirmation is performed in the order of increasing the device number 181. Thus, the connection confirmation for the external apparatus which is highly possibly connected to the television 1 can be early performed. Also, the confirmation for the situation, having the low possibility of being generally implemented with a connection form, that a plurality of apparatuses having the same device type are connected to the television 1 can be performed later. As a result, although the processing time required for the connection confirmation remains unchanged, the television 1 confirms in the early stage the connection of the external apparatuses to the television 1. Therefore, the operation of the television 1 can quickly proceed to the recognition of the external apparatuses on the television 1, and the manipulation for the external apparatuses through the television 1.

It is noted that the number of external apparatuses connected to the television 1, and the kinds thereof in the HDMI system 100 can be arbitrarily changed. It is noted that the logic address assignment table 18A is not limited to one shown in FIG. 4A, and can be arbitrarily changed. Also, it is noted that when the device number 181 and the device type 182 are set for each of the address numbers of “12” and “13” in the logic address 180, the processing for the address numbers of “12” and “13” in the logic address 180 is also included in the processing from Step S11 to Step S15.

In addition, the address number of “0” in the logic address 180 can be used for a display device such as a display device for a PC or a monitor which has the HDMI-CEC function in addition to the television 1.

### Second Embodiment

### (Operation)

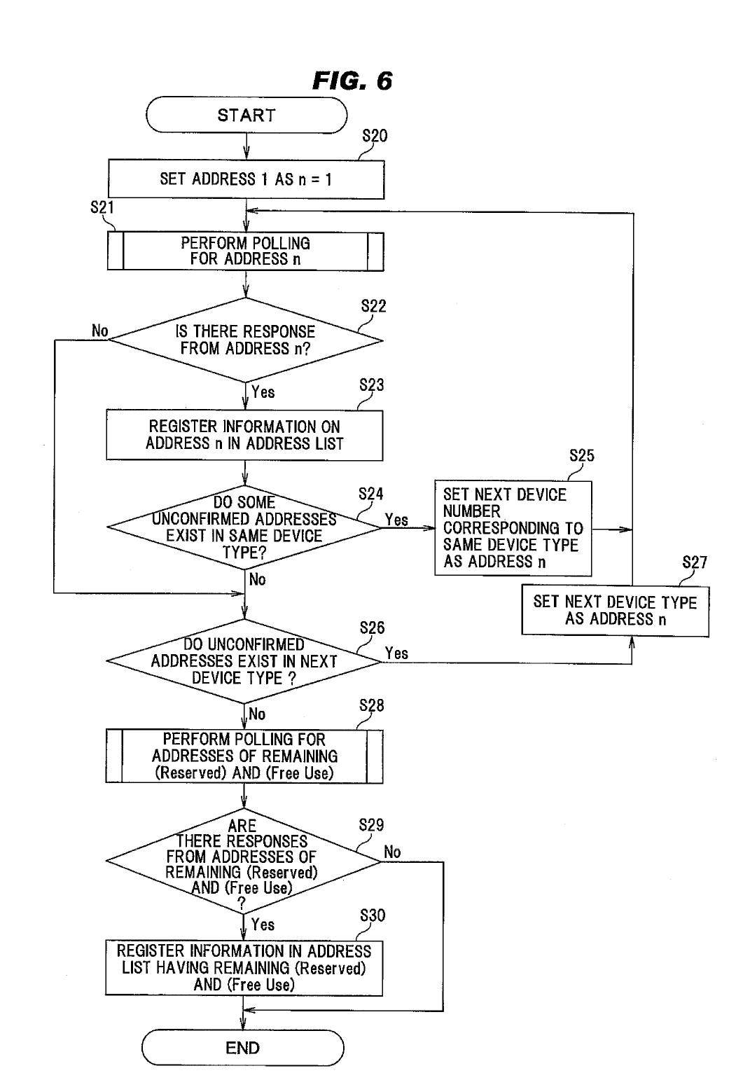

FIG. 6 is a flow chart showing an operation of a television according to a second embodiment of the invention. Note that, in the following description, portions having the same constitutions and functions as those in the first embodiment are designated with the same reference numerals, respectively.

Firstly, the CPU 16 sets n=1 in order to confirm the connection of an external apparatus corresponding to the address number of “1” in the logic address 180 (Step S20). Next, the CPU 16 performs the polling “<Give Physical Address>” for the address number of “1” in the logic address 180, that is, for “Recording Device 1” (Step S21). When there is a response, to the polling, from the address number of “1” in the logic address 180 because the external apparatus is connected to the television 1 so as to correspond to the address number of “1” in the logic address 180 (Step S22: Yes), the physical address 183 and the device name 184 of that external apparatus as the response contents are written to and registered in the address list 18B so as to correspond to the address number of “1” in the logic address 180 (step S23). Next, when the some external apparatuses for each of which no connection confirmation is performed exist in corresponding address numbers in the logic address 180 belonging to “Recording Device” and having the same device type 182, that is, in the address numbers of “2” and “9” in the logic address 180 (Step S24: Yes), the smallest address number of them in the logic address 180, for example, the address number of “2” in the logic address 180 is selected. Then, the operation of the television 1 returns back to the processing in Step S21. In addition, when no external apparatus for which no connection confirmation is performed exists in the address numbers in the logic address 180 belonging to the same device type 182 (Step S24: No), the operation of the television 1 proceeds to processing in next Step S26. On the other hand, when there is no response from the external apparatus (Step S22: No), none of the physical address 183 and the device name 184 is written to the address list 18B, and the operation of the television 1 then proceeds to processing in Step S26. In addition, the connection confirmations for the external apparatuses corresponding to the following device numbers 181 and having the same device type 182 is performed later.

Next, when some address numbers in the logic address 180 for each of which no connection confirmation is performed exist in the address numbers of “3” , “6” and “7” in the logic address 180 each corresponding to “Tuner” as the device type 182 next to “Recording Device” (Step S26: Yes), the smallest address number in the logic address 180 for which no connection confirmation is performed is selected as the address number in the logic address 180. For example, when no connection confirmation is performed for each of the external apparatuses corresponding to the address numbers of “3”, “6” and “7” in the logic address 180, the address number of “3” in the logic address 180 is selected (Step S27), and the operation of the television 1 returns back to the processing in Step S21.

Here, all the connection confirmations are not performed in the phase of the activation of the television 1. Thus, by repeatedly executing the processing from Step S21 to Step S27, the connection confirmation is performed for the address numbers in the logic address 180 in the order as will be described below: “1 (Recording Device 1)”, “2 (Recording Device 2)”, “9 (Recording Device 3)”, “3 (Tuner 1)”, “6 (Tuner 2)”, “7 (Tuner 3)”, “10 (Tuner 4)”, “4 (Playback Device 1)”, “8 (Playback Device 2)”, “11 (Playback Device 3)”, and “5 (Audio System)”. However, at a time point when the external apparatus appears for which no connection confirmation can be performed, the connection confirmations for the external apparatuses following that external apparatus and corresponding to the subsequent device numbers 181 each belonging to the device type 182 are performed later. That is to say, the connection confirmation is repeatedly performed such that the connection confirmation is successively performed for the first external apparatus and the second external apparatus each corresponding to a certain device type 182, and at a time point when the external apparatus appears for which no connection confirmation can be performed, for example, when no connection confirmation can be performed for the second external apparatus, the connection confirmation for the third external confirmation is left until later, and the operation proceeds to the connection confirmations for the external apparatuses each belonging to the next device type 182.

Next, when the connection confirmation is completed for each of the external apparatuses belonging to all the device types 182 (Step S26: No), the polling is performed for the external apparatuses connected to the television 1 so as to correspond to the address numbers in the logic address 180 the confirmation for each of which will be performed later of the address numbers of “1” to “11” in the logic address 180, and the address numbers of “12” to “15” in the logic address 180 (Step S28). When there are responses, to the polling, from the external apparatuses connected to the television 1 so as to correspond to the address numbers in the logic address 180 the confirmation for each of which will be performed later of the address numbers of “1” to “11” in the logic address 180, and the address numbers of “12” to “15” in the logic address 180 (Step S29: Yes), the physical addresses 183 and the device names 184 of these external apparatuses, connected to the television 1, each making the response to the polling are written to and registered in the address list 18B (Step S30). On the other hand, when there is no response, to the polling, from none of these external apparatuses connected to the television 1 so as to correspond to the address numbers in the logic address 180 the confirmation for each of which will be performed later, and the address numbers of “12” to “15” in the logic address 180 (Step S29: No), the connection confirmation is completed.

According to the second embodiment described above of the invention, conventionally, the connection confirmation is performed in the order of increasing the number of the logic address 180, whereas the connection confirmation is performed every device type 182, and the connection confirmations for the external apparatuses corresponding to the device numbers 181 following the external apparatus for which no connection confirmation can be performed are performed later. Thus, the connection confirmation for the external apparatus which is highly possibly connected to the television 1 can be early performed. Also, the confirmation for the situation, having the low possibility of being generally implemented with the connection form, that the external apparatus is connected earlier to the television 1 so as to correspond to the large device number 181 than the external apparatus is connected to the television 1 so as to correspond to the small device number 181 can be performed later. As a result, although the processing time period for the connection confirmation remains unchanged, the television confirms in the early stage the connection of the external apparatuses to the television 1. Therefore, the operation of the television 1 can quickly proceed to the recognition of the external apparatuses on the television 1, and the manipulation for the external apparatuses through the television 1.

### Third Embodiment

### (Constitution)

The information on the connection situation of the external apparatuses when the operation of the television 1 ends is stored in the form of the same description as that in the address list 18B shown in FIG. 4B in the last-time address list 18C shown in FIG. 3.

(Operation)

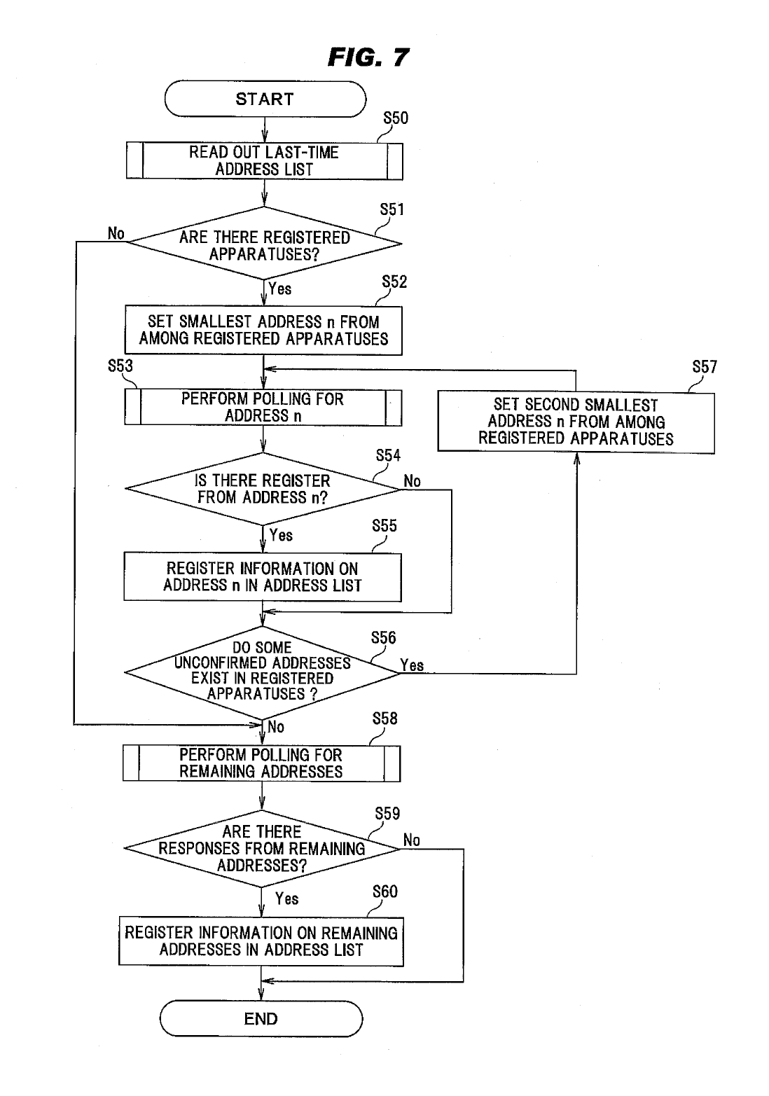

FIG. 7 is a flow chart showing an operation of a television according to a third embodiment of the invention.

Firstly, the CPU 16 reads out the last-time address list 18C from the ROM 18 (Step S50). Next, when there are the external apparatuses which are registered during the last-time connection confirmation (Step S51: Yes), the CPU 16 sets the smallest address number in the logic address 180 to which one external apparatus of the registered external apparatuses corresponds by referring to the last-time address list 18C (Step S52). For example, in the case of the last-time address list 18C as shown in FIG. 4B, the external apparatuses corresponding to the address numbers of “1”, “3”, “4” and “5” in the logic address 180 are previously registered in the last-address list 18C. Thus, the address number of “1” in the logic address 180 is firstly set and the polling “<Give Physical Address>” is performed for “Recording Device 1” (Step S53). When the external apparatus is connected to the television 1 so as to correspond to the address number of “1” in the logic address 180, and a response is made therefrom (Step S54: Yes), the physical address 183 and the device name 184 of the external apparatus connected as the response contents are written to and registered in the address list 18B so as to correspond to the address number of “1” in the logic address 180 (Step S55). On the other hand, when the external apparatus corresponding to the address number of “1” in the logic address 180 is taken away from the television 1 and thus no response is made therefrom (Step S54: No), none of the physical address 183 and the device name 184 is written to the address list 18B so as to correspond to the address number of “1” in the logic address 180, and “None” is set in each of the physical address 183 and the device name 184, and the operation of the television 1 proceeds to processing in Step S56.

Next, when some address numbers in the logic address 180 for each of which no connection confirmation is performed exist in the address numbers of “3”, “4” and “5” in the logic address 180 of the registered external apparatuses (Step S56: Yes), the smallest address number in the logic address 180 for which no connection confirmation is performed is selected as the address number in the logic address 180. For example, when no connection confirmation is performed for each of the registered external apparatuses corresponding to the address numbers of “3”, “4” and “5” in the logic address 180, the address number of “3” in the logic address is selected as the smallest address number in the logic address 180 (Step S57), and the operation of the television 1 returns back to the processing in Step S53.

Here, by repeatedly executing the processing from Step S52 to Step S57, the connection confirmation is performed for each of the address numbers in the logic address 180 in the following order: “1 (Recording Device 1)”, “3 (Tuner 1)”, “4 (Playback Device 1)”, and “5 (Audio System)”.

Next, when it is completed that the connection confirmation is performed for each of all the registered external apparatuses corresponding to the address numbers in the logic address 180, respectively (Step S56: No), the polling is performed for the external apparatuses, for each of which the connection is unconfirmed, of the external apparatuses corresponding to the address numbers of “1” to “11” in the logic address 180, respectively, and the external apparatuses corresponding to the address numbers of “12” to “15” in the logic address 180, respectively (Step S58). When there are responses, to the polling, therefrom (Step S59: Yes), the physical addresses 183 and the device names 184 of these external apparatuses each making the response to the polling are written to and registered in the address list 18B (Step S60). On the other hand, when there is no response, to the polling, therefrom (Step S59: No), the connection confirmation is completed.

It is noted that the method of the first embodiment or the second embodiment is applied to the processing from Step S58 to Step S60.

According to the third embodiment described above of the invention, the last-time address list 18C is read out, and the connection confirmation is performed preferentially from the registered external apparatuses, which results in that the connection confirmation for the external apparatus which is highly possibly connected to the television 1 can be early performed. Also, the confirmation for the situation, having the low possibility of being generally implemented with the connection form, that the external apparatus is frequently connected to and taken away from the television 1 can be performed later. As a result, although the processing time required for the connection confirmation remains unchanged, the television 1 confirms in the early stage the connection of the external apparatuses to the television 1. Therefore, the operation of the television 1 can quickly proceed to the recognition of the external apparatuses on the television 1, and the manipulation for the external apparatuses through the television 1.

It is noted that the last-time address list 18C may be statistically processed in accordance with the history about a plurality of connection confirmations, and may learn the external apparatuses each having the high frequency of being connected to the television 1.

It is noted that the third embodiment can be implemented not only in the phase of execution of the processing for activating the television 1 from a standby state to an operatable state, but also during the connection confirmation which is periodically performed in the phase of the normal operation of the television 1.

For example, when the connection confirmation is periodically performed in the phase of the normal operation of the television 1, the address numbers in the logic address 180 to which the external apparatuses which are confirmed in connection to the television 1 in the first connection confirmation correspond, respectively, are stored in the last-time address list 18C. Also, the external apparatuses corresponding to the address numbers in the logic address 180 registered in the last-time address list 18C, respectively, are periodically confirmed in their connections to the television 4. On the other hand, the external apparatuses corresponding to the address numbers in the logic address 180 not registered in the last-time address list 18C, respectively, are confirmed in connection to the television 1 at a lower frequency than that for the connection confirmation performed for the external apparatuses corresponding to the address numbers in the logic addresses 180 registered in the last-time address list 18C, respectively.

More specifically, the frequency of the connection confirmation is changed such that the connection confirmation is performed at intervals of one minute for each of the external apparatuses corresponding to the address numbers in the logic address 180, respectively, which are registered in the last-time address list 18C, while the connection confirmation is performed at intervals of two minutes for each of the external apparatuses corresponding to the address numbers in the logic address 180, respectively, which are not registered in the last-time address list 18C. As a result, it is possible to reduce the number of times of the confirmation for the situation, having the low possibility of being generally implemented with the connection form, that the HDMI cable 6 is attached to and detached from the television 1 or the corresponding one of the external apparatuses when being used. Therefore, it is possible to reduce the burden imposed on the processing for the connection confirmation.

### Fourth Embodiment

### (Construction)

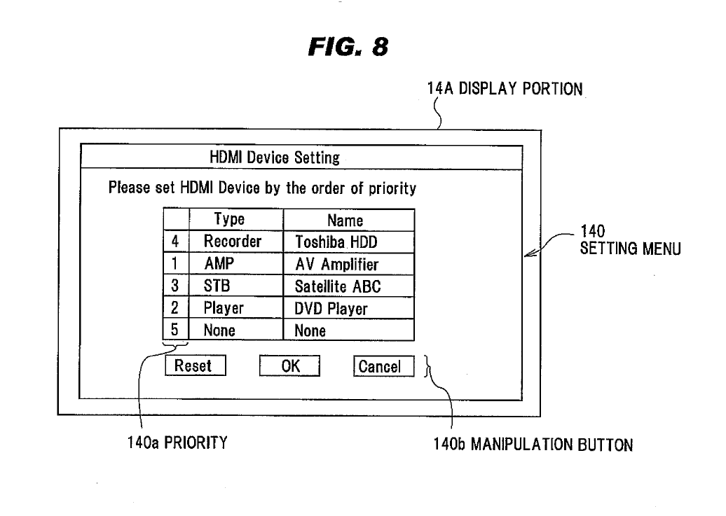

FIG. 8 is a schematic diagram showing a setting menu displayed on a display portion of a television according to a fourth embodiment of the invention.

A setting menu 140 is displayed on the display portion 14A of the television 1 by performing a predetermined manipulation by using either the manipulation portion 19 or the remote controller 1B. The setting menu 140 is a setting picture with which a priority is determined for the performing of the connection confirmations. In this case, the connection confirmation is performed for each of the external apparatuses connected to the television 1 through the corresponding one of the HDMI cables 6 in accordance with the priority thus determined. Information on the external apparatuses which are registered in the address list 18B based on the connection confirmations therefor is displayed on a table on the setting menu 140. A priority 140a can be determined for each of the external apparatuses by inputting numeral information or the like by using a ten key or the like of the remote controller 1B. The inputted contents are reset, determined or canceled by manipulating corresponding one of manipulation buttons 140b.

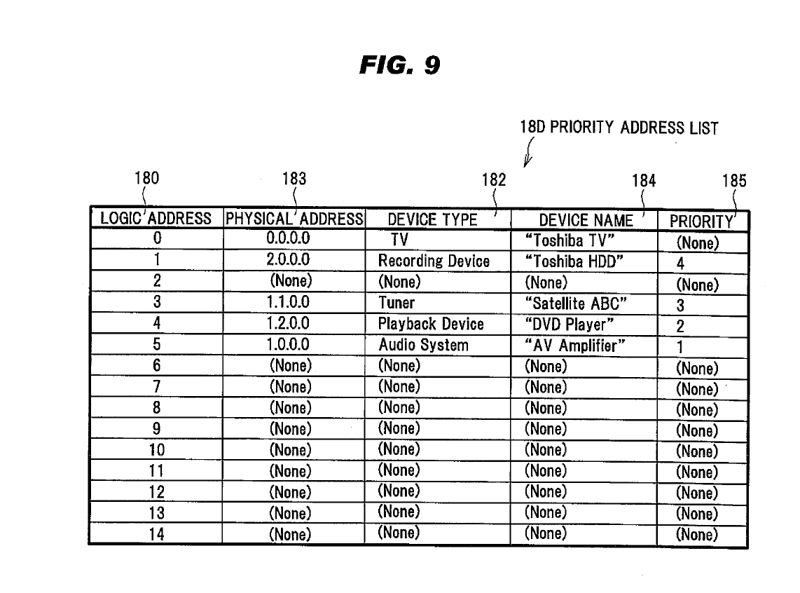

FIG. 9 is a table showing a structure of a priority address list in the fourth embodiment of the invention.

A priority address list 18D is one which is obtained by adding an item of a priority 185 to the address list 18B shown in FIG. 4B, and is used to confirm the priority when the television 1 confirms the external apparatuses connected to the television 1 through the corresponding ones of the MDMI cables 6. The physical addresses 183 and the device names 184 use the contents which are registered when the connection confirmation is performed last time for each of the external apparatuses connected to the television 1. Thus, the same effects as those of the third embodiment can be obtained by utilizing these registered contents during the connection confirmation.

(Operation)

Firstly, a user sets the priority 140a for the connection confirmation performed for each of the connected external apparatuses from the setting menu 140, and ends the operation of the television 1. Next, when the power source of the television 1 is turned ON, the CPU 16 performs the connection confirmation as well as the activation processing. In this case, the CPU 16 reads out the priority address list 18D when starting to perform the connection confirmation, and firstly performs the connection confirmation in accordance with the priority 185.

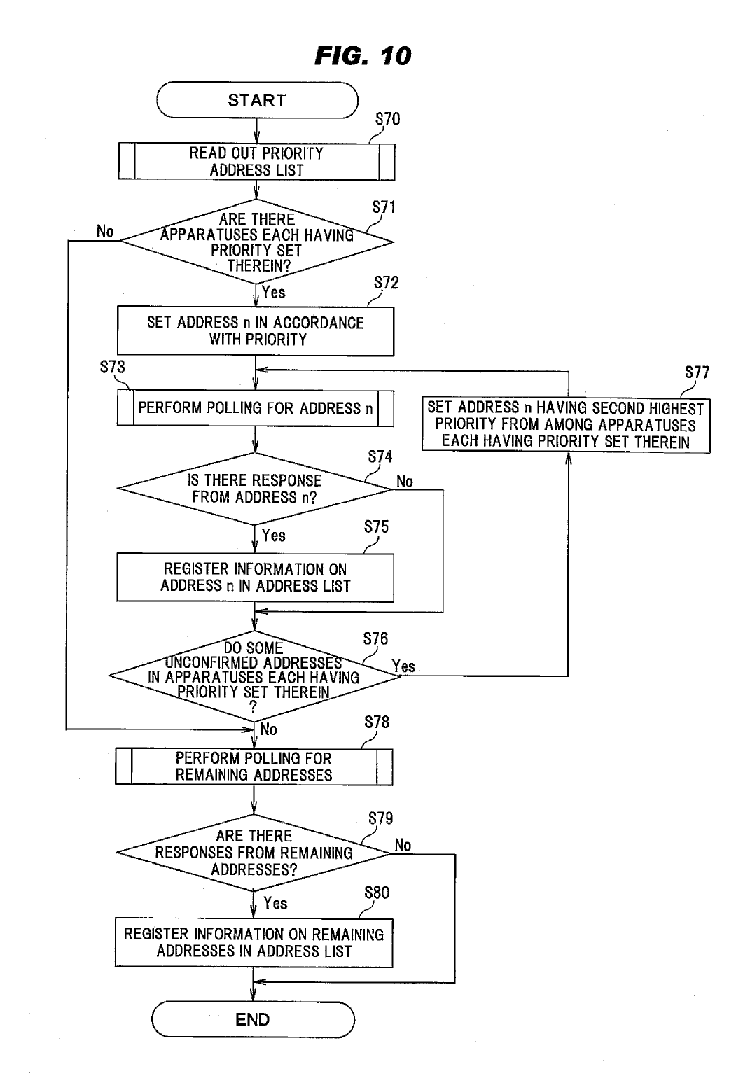

FIG. 10 is a flow chart showing an operation of the television according to the fourth embodiment of the invention.

Firstly, the CPU 16 reads out the priority address list 18D from the ROM 18 (Step S70). Next, when there are the external apparatuses each having the priority 185 set therein (Step S71: Yes), the CPU 16 sets the address number, in the logic address 180, having the highest priority in accordance with the priority 185 by referring to the priority address list 18D (Step S72). For example, in the case of the priority address list 18D as shown in FIG. 9, the priority 185 is previously set in each of the external apparatuses corresponding to the address numbers of “1”, “3”, “4” and “5” in the logic address 180, respectively. Hence, the CPU 16 sets the address number of “5”, in the logic address 180, having the highest priority 185, and performs the polling “<Give Physical Address>” for “Audio System” (Step S73). When the external apparatus is connected to the television 1 so as to correspond to the address number of “5” in the logic address 180, and makes a response to the polling (Step S74: Yes), the physical address 183 and the device name 184 of that external apparatus as the response contents are written to and registered in the address list 18B so as to correspond to the address number of “5” in the logic address 180 (Step S75). On the other hand, when the external apparatus corresponding to the address number of “5” in the logic address 180 is taken away from the television 1 and makes no response to the polling (Step S74: No), none of the physical address 183 and the device name 184 is written to the address list 18B so as to correspond to the address number of “5” in the logic address 180, and “None” is set in each of the physical address 183 and the device name 184. Then, the operation of the television 1 proceeds to processing in Step S76.

Next, when some address numbers in the logic address 180 for each of which no connection confirmation is performed exist in the address numbers of “1”, “3” and “4” in the logic address 180 to which the external apparatuses each having the priority 185 set therein correspond, respectively (Step S76: Yes), the CPU 16 selects the address in the logic address number 180, having the second highest priority set therein, as one in the logic address 180. For example, when no connection confirmation is performed for each of the external apparatuses corresponding to the address numbers of “1”, “3” and “4” in the logic address 180, respectively, the CPU 16 selects the address number of “4” in the logic address 180 (Step S77), and the operation of the television 1 returns back to the processing in Step S73.

Here, by repeatedly executing the processing from Step S72 to Step S77, the connection confirmation is performed for each of the address numbers in the logic address 180 in the following order: “5 (Audio System)”, “4 (Playback Device 1)”, “3 (Tuner 1)”, and “1 (Recording Device 1)”.

Next, when it is completed that the connection confirmation is performed for each of the address numbers in the logic address 180 to which all the external apparatuses each having the priority 185 set therein correspond, respectively (Step S76: No), the polling is performed for the external apparatus, for each of which the connection is unconfirmed, of the external apparatuses corresponding to the address numbers of “1” to “11” in the logic address 180, respectively, and the external apparatuses corresponding to the address numbers of “12” to “15” in the logic address 180, respectively (Step S78). When there are responses, to the polling, therefrom (Step S79: Yes), the physical addresses 183 and the device names 184 of these external apparatuses, connected to the television 1, each making the response to the polling are written to and registered in the address list 18B (Step S80). On the other hand, when there is no response, to the polling, therefrom (Step S79: No), the connection confirmation is completed.

It is noted that the method of the first embodiment or the second embodiment is applied to the processing from Step S78 to Step S80. In addition, in the case, the method of the third embodiment may also be used concomitant with the method of the first embodiment or the second embodiment.

According to the fourth embodiment described above of the invention, the priority address list 18D is read out, and the connection confirmation is performed in accordance with the priority 185, which results in that the connection confirmation for the external apparatus which is highly possibly connected to the television 1 can be performed early in accordance with an intention of the user. As a result, although the processing time required for the connection confirmation remains unchanged, the television 1 confirms in the early stage the connection of the external apparatuses to the television 1. Therefore, the operation of the television 1 can quickly proceed to the recognition of the external apparatuses on the television 1, and the manipulation for the external apparatuses through the television 1.

It is noted that the fourth embodiment can be implemented not only in the phase of execution of the processing for activating the television 1 from the standby state to the operatable state, but also during the connection confirmation which is periodically performed in the phase of the normal operation of the television 1 similarly to the case of the third embodiment.

For example, when the connection confirmation is periodically performed in the phase of the normal operation of the television 1, the external apparatuses corresponding to the address numbers in the logic address 180, respectively, which are registered in the priority address list 18D are periodically confirmed in connection to the television 1. On the other hand, the external apparatuses corresponding to the address numbers in the logic address 180, respectively, which are not registered in the priority address list 18D are confirmed in connection to the television 1 at a lower frequency than that for the connection confirmation performed for the external apparatuses corresponding to the address numbers in the logic address 180, respectively, which are registered in the primary address list 180.

More specifically, the frequency of the connection confirmation is changed such that the connection confirmation is performed at intervals of one minute for each of the external apparatuses corresponding to the address numbers in the logic address 180, respectively, which are registered in the priority address list 18D, while the connection confirmation is performed at intervals of two minutes for each of the external apparatuses corresponding to the address numbers in the logic address 180, respectively, which are not registered in the priority address list 18D. As a result, it is possible to reduce the number of times of the confirmation for the situation, having the low possibility of being generally implemented with the connection form, that the HDMI cable 6 is attached to and detached from the television 1 or the corresponding one of the external apparatuses when being used. Therefore, it is possible to reduce the burden imposed on the processing for the connection confirmation.

It should be noted that the present invention is not limited to the embodiments described above, and the various combinations and changes may be made without departing from or changing the technical idea of the present invention.

What is claimed is:

1. An electronic apparatus, comprising:
a communication line through which the electronic apparatus communicates with a plurality of external apparatuses;
a memory portion for storing therein an address list in which correspondence between logic addresses and physical addresses of the plurality of external apparatuses is made; and
a control portion for determining a search order for the logic addresses in accordance with a predetermined rule, searching for the plurality of external apparatuses connected to the electronic apparatus through the communication line in accordance with the search order, acquiring the physical addresses from the plurality of external apparatuses, and writing the physical addresses thus acquired to the address list.

2. An electronic apparatus according to claim 1, wherein the control portion searches for the plurality of external apparatuses in a device number order every device type of the plurality of external apparatuses as the predetermined rule.

3. An electronic apparatus according to claim 1, wherein the control portion searches for the plurality of external apparatuses of different device types every device number of the plurality of external apparatuses as the predetermined rule.

4. An electronic apparatus according to claim 1, wherein the memory portion stores therein a last-time address list to which the physical addresses are written when the control portion searches for the plurality of external apparatuses last time; and
the control portion searches for the plurality of external apparatuses by prioritizing the logic addresses of the external apparatuses described in the last-time address list.

5. An electronic apparatus according to claim 1, wherein the memory portion stores therein a priority address list in which a search order in accordance with which the control portion preferentially searches for the plurality of external apparatuses is previously determined; and
the control portion searches for the plurality of external apparatuses in accordance with the search order previously determined in the priority address list.

6. An electronic apparatus according to claim 1, wherein the control portion searches for the plurality of external apparatuses when a power source of the electronic apparatus is turned ON.

7. An electronic apparatus according to claim 4, wherein the control portion periodically searches for the plurality of external apparatuses during a normal operation of the electronic apparatus, and makes a frequency of search for the logic address of the external apparatus which is not described in the last-time address list smaller than that of search for the logic address of the external apparatus which is described in the last-time address list.

8. An electronic apparatus according to claim 5, wherein the control portion periodically searches for the plurality of external apparatuses during a normal operation of the electronic apparatus, and makes a frequency of search for the logic address of the external apparatus which is not described in the priority address list smaller than that of search for the logic address of the external apparatus which is described in the priority address list.

9. An electronic apparatus, comprising:
a communication line through which the electronic apparatus communicates with a plurality of external apparatuses;
a memory portion for storing therein an address list in which correspondence between logic addresses and physical addresses of the plurality of external apparatuses is made, and a last-time address list in which a history about the correspondence between the logic addresses and the physical addresses of the plurality of external apparatuses is stored; and
a control portion for determining a search order for the logic addresses in accordance with the logic addresses of the external apparatuses described in the last-time address list preferentially and a predetermined rule, searching for the plurality of external apparatuses connected to the electronic apparatus through the communication line in accordance with the search order, acquiring the physical addresses from the plurality of external apparatuses, and writing the physical addresses thus acquired to the address list.

10. An electronic apparatus according to claim 9, wherein the control portion searches for the plurality of external apparatuses in a device number order every device type of the plurality of external apparatuses as the predetermined rule.

11. An electronic apparatus according to claim 9, wherein the control portion searches for the plurality of external apparatuses of different device types every device number of the plurality of external apparatuses as the predetermined rule.

12. An electronic apparatus according to claim 9, wherein the memory portion stores therein a priority address list in which a search order in accordance with which the control portion preferentially searches for the plurality of external apparatuses is previously determined; and
the control portion searches for the plurality of external apparatuses in accordance with the search order previously determined in the priority address list.

13. An electronic apparatus according to claim 9, wherein the control portion searches for the plurality of external apparatuses when a power source of the electronic apparatus is turned ON.

14. An electronic apparatus according to claim 9, wherein the control portion periodically searches for the plurality of external apparatuses during a normal operation of the electronic apparatus, and makes a frequency of search for the logic address of the external apparatus which is not described in the last-time address list smaller than that of search for the logic address of the external apparatus which is described in the last-time address list.

15. An electronic apparatus according to claim 12, wherein the control portion periodically searches for the plurality of external apparatuses during a normal operation of the electronic apparatus, and makes a frequency of search for the logic address of the external apparatus which is not described in the priority address list smaller than that of search for the logic address of the external apparatus which is described in the priority address list.

16. A connected apparatus searching method, comprising the steps of:
determining a search order for logical addresses in accordance with a predetermined rule;
searching for a plurality of external apparatuses in accordance with the search order thus determined; and
acquiring physical addresses from the plurality of external apparatuses thus searched for, and writing physical addresses to an address list so as to correspond to the logic addresses, respectively.

17. A connected apparatus searching method according to claim 16, wherein in the determining step, the search order is determined so as to search for the plurality of external apparatuses in a device number order every device type of the plurality of external apparatuses as the predetermined rule.

18. A connected apparatus searching method according to claim 16, wherein in the determining step, the search order is determined so as to search for the plurality of external apparatuses of different device types every device number of the plurality of external apparatuses as the predetermined rule.

19. A connected apparatus searching method according to claim 16, wherein in the searching step, the plurality of external apparatuses are searched for in accordance with a priority address list in which a search order in accordance with which the plurality of external apparatuses are preferentially searched for is previously determined.

20. A connected apparatus searching method according to claim 16, wherein in the searching step, the plurality of external apparatuses are searched for when a power source is turned ON.
